(19) United States
(12) Patent Application Publication
(10) Pub. No.: US 2023/0136608 A1
(43) Pub. Date: May 4, 2023

(54) SYSTEM AND METHODS FOR ADVERTISEMENT ENHANCEMENT

(71) Applicant: Capped Out Media, Taylorsville, UT (US)

(72) Inventor: Waynard Schmidt, Taylorsville, UT (US)

(73) Assignee: Capped Out Media, Taylorsville, UT (US)

(21) Appl. No.: 17/513,131

(22) Filed: Oct. 28, 2021

(51) Int. Cl. G06Q 30/02; H04L 29/06

(52) U.S. Cl. CPC G06Q 30/0257; H04L 65/4084

(57) ABSTRACT

A system for enhancing advertisement interaction, which may include receiving, from a publisher, media content, and media information; creating, form the media content, at least one media audio fingerprint; storing, on a database, the at least one media audio fingerprint and the media information; receiving, from an electronic device, a device input; creating, from the device input, at least one input audio fingerprint; matching at least one media audio fingerprint with at least one input audio fingerprint; retrieving from the database the media information related to the matched media audio fingerprint; displaying, via a display of the electronic device, the retrieved media information. The electronic device may include a microphone.

### FIELD OF INVENTION

The present invention is in the field of content-based information retrieval, specifically recognition of an advertisement and later display of related information.

### INTRODUCTION

Advertising is a huge industry that permeates through the lives of most people. Additionally, there are many instances where information is communicated to persons which may be of interest to that person. A problem arises when people are preoccupied and/or unable to immediately act on the information they have just received. An example of this is a person listening to an advertisement on the radio while driving. The person may find the advertisement to be of interest, but may forget to follow up on the advertisement once they have finished driving.

Additionally, some advertisements may comprise information that is difficult to immediately remember (e.g., a phone number, or website uniform resource locator). This means that a person may miss out on benefitting from the information conveyed because they were unable to manually record the information and are unable to recall necessary parts of the information.

Accordingly, it is desirable to have a system that detects information conveyed to a user, and provides a convenient way to allow users to follow up on such information.

### SUMMARY

In an aspect of this disclosure, a system for enhancing advertisement interaction on an electronic device may include one or more processors, one or more computer-readable memories, and one or more computer-readable storage devices, and program instructions stored on at least one of the one or more storage devices for execution by at least one of the one or more processors via at least one of the one or more memories. The stored program instructions may include receiving, from a publisher, media content, and media information; creating, form the media content, at least one media audio fingerprint; storing, on a database, the at least one media audio fingerprint and the media information; receiving, from an electronic device, a device input; creating, from the device input, at least one input audio fingerprint; matching at least one media audio fingerprint with at least one input audio fingerprint; retrieving from the database the media information related to the matched media audio fingerprint; displaying, via a display of the electronic device, the retrieved media information. The electronic device may include a microphone.

In an embodiment, the media information may be at least one of navigation information, uniform resource locator, pricing information, or phone number.

In another embodiment, the electronic device may be a mobile phone.

In yet another embodiment, the electronic device may be a desktop computer.

In another embodiment, the electronic device may further include a camera.

In an embodiment, the device input may include a five-second audio sample.

In another embodiment, more than one five-second audio samples may be recorded in continuous succession.

In yet another embodiment, receiving, from an electronic device, a device input, may be contingent on an activation of a button. The button may include a digital button displayed on the display of the electronic device.

In an embodiment, the button may include a physical button operatively connected to the electronic device. The physical button may be a latching switch.

In another embodiment, the stored program instructions may further include presenting, via the display of the electronic device, a selectable retrieved media information; recording, via the one or more storage devices, an interaction data to the database; maintaining a portal, via the one or more storage devices, accessible by the publisher; and displaying, via the portal, the interaction data. Interaction with the selectable retrieved media information may generate one or more clicks. The interaction data may include a time of the one or more clicks, a quantity of the one or more clicks per the retrieved media information, a device type, a geographical location, and/or a quantity of phone calls.

In yet another embodiment, the geographical location may be determined based on an area code from an outgoing phone call, via the electronic device.

In an embodiment, the stored program instructions may further include embedding, via the one or more processors, an identifying tone in the at least one media audio fingerprint. The electronic device may be configured to begin receiving the device input based on the identifying tone.

In another embodiment, the stored program instructions may further including providing, via the portal, a plurality of tiers; and accepting, via the portal, a payment information from the publisher. The publisher may select from the plurality of tiers. Additionally, each of the plurality of tiers may correlate to the retrieved media information.

In yet another embodiment, the plurality of tiers may include a first tier, a second tier, and a third tier. In the first tier, the retrieved media information may include at least a URL. For the second tier, the retrieved media information may include at least the URL and a phone number. For the third tier, the retrieved media information may include at least the URL, the phone number, and a message.

Additional aspects related to this disclosure are set forth, in part, in the description which follows, and, in part, will be obvious from the description, or may be learned by practice of this disclosure.

It is to be understood that both the forgoing and the following descriptions are exemplary and explanatory only and are not intended to limit the claimed disclosure or application thereof in any manner whatsoever.

### BRIEF DESCRIPTION OF THE DRAWINGS

The incorporated drawings, which are incorporated in and constitute a part of this specification exemplify the aspects of the present disclosure and, together with the description, explain and illustrate principles of this disclosure.

FIG. 1 illustrates a block diagram of a distributed computer system that can implement one or more aspects of an embodiment of the present invention.

FIG. 2 illustrates a block diagram of an electronic device that can implement one or more aspects of an embodiment of the invention.

FIG. 3 shows an embodiment of a system for storing and indexing media data.

FIG. 4 shows an embodiment of a system for matching media and displaying information to a user.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific aspects, and implementations consistent with principles of this disclosure. These implementations are described in sufficient detail to enable those skilled in the art to practice the disclosure and it is to be understood that other implementations may be utilized and that structural changes and/or substitutions of various elements may be made without departing from the scope and spirit of this disclosure. The following detailed description is, therefore, not to be construed in a limited sense.

It is noted that description herein is not intended as an extensive overview, and as such, concepts may be simplified in the interests of clarity and brevity.

All documents mentioned in this application are hereby incorporated by reference in their entirety. Any process described in this application may be performed in any order and may omit any of the steps in the process. Processes may also be combined with other processes or steps of other processes.

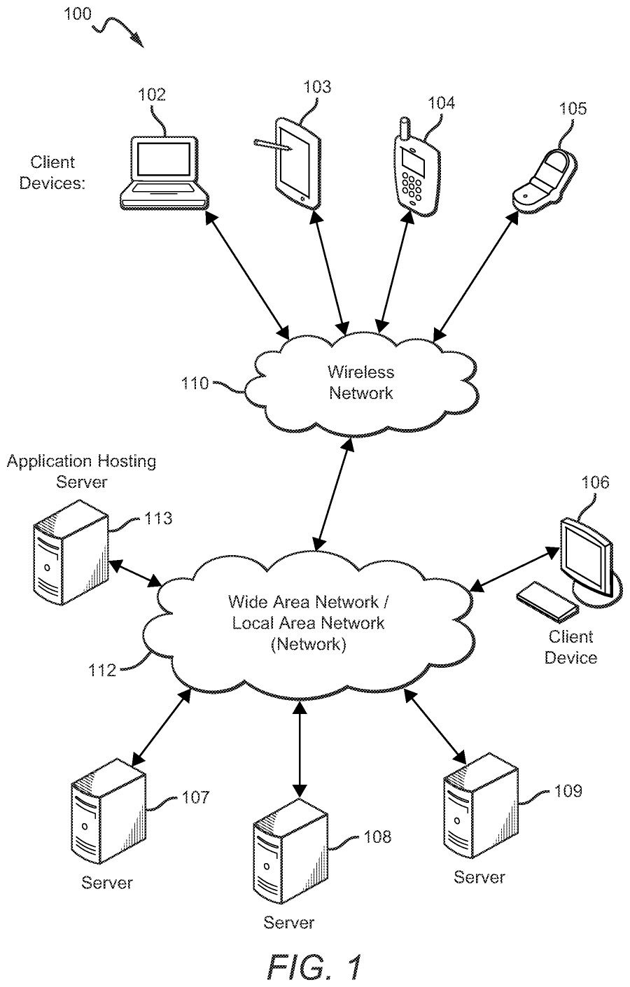

FIG. 1 illustrates components of one embodiment of an environment in which the invention may be practiced. Not all of the components may be required to practice the invention, and variations in the arrangement and type of the components may be made without departing from the spirit or scope of the invention. As shown, the system 100 includes one or more Local Area Networks (“LANs”)/Wide Area Networks (“WANs”) 112, one or more wireless networks 110, one or more wired or wireless client devices 106, mobile or other wireless client devices 102-105, servers 107-109, and may include or communicate with one or more data stores or databases. Various of the client devices 102-106 may include, for example, desktop computers, laptop computers, set top boxes, tablets, cell phones, smart phones, smart speakers, wearable devices (such as the Apple Watch) and the like. Servers 107-109 can include, for example, one or more application servers, content servers, search servers, and the like. FIG. 1 also illustrates application hosting server 113.

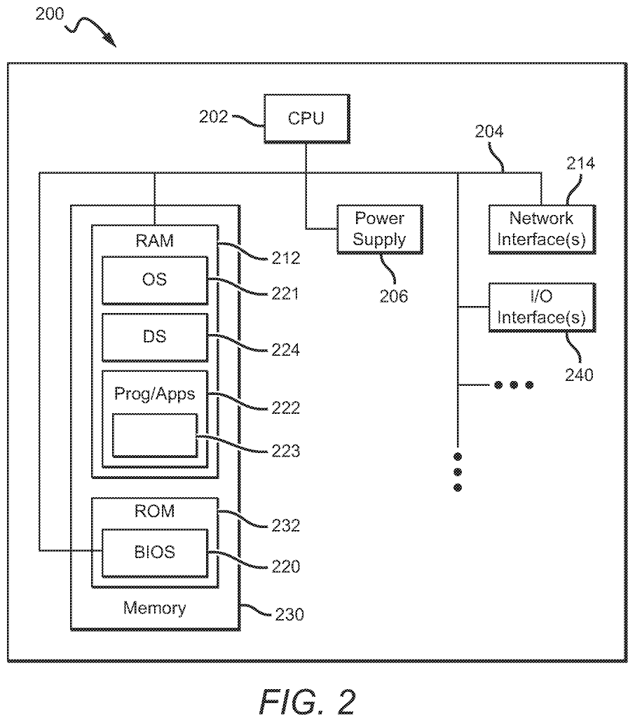

FIG. 2 illustrates a block diagram of an electronic device 200 that can implement one or more aspects of an apparatus, system and method for increasing mobile application user engagement (the “Engine”) according to one embodiment of the invention. Instances of the electronic device 200 may include servers, e.g., servers 107-109, and client devices, e.g., client devices 102-106. In general, the electronic device 200 can include a processor/CPU 202, memory 230, a power supply 206, and input/output (I/O) components/devices 240, e.g., microphones, speakers, displays, touchscreens, keyboards, mice, keypads, microscopes, GPS components, cameras, heart rate sensors, light sensors, accelerometers, targeted biometric sensors, etc., which may be operable, for example, to provide graphical user interfaces or text user interfaces.

A user may provide input via a touchscreen of an electronic device 200. A touchscreen may determine whether a user is providing input by, for example, determining whether the user is touching the touchscreen with a part of the user's body such as his or her fingers. The electronic device 200 can also include a communications bus 204 that connects the aforementioned elements of the electronic device 200. Network interfaces 214 can include a receiver and a transmitter (or transceiver), and one or more antennas for wireless communications.

The processor 202 can include one or more of any type of processing device, e.g., a Central Processing Unit (CPU), and a Graphics Processing Unit (GPU). Also, for example, the processor can be central processing logic, or other logic, may include hardware, firmware, software, or combinations thereof, to perform one or more functions or actions, or to cause one or more functions or actions from one or more other components. Also, based on a desired application or need, central processing logic, or other logic, may include, for example, a software-controlled microprocessor, discrete logic, e.g., an Application Specific Integrated Circuit (ASIC), a programmable/programmed logic device, memory device containing instructions, etc., or combinatorial logic embodied in hardware. Furthermore, logic may also be fully embodied as software.

The memory 230, which can include Random Access Memory (RAM) 212 and Read Only Memory (ROM) 232, can be enabled by one or more of any type of memory device, e.g., a primary (directly accessible by the CPU) or secondary (indirectly accessible by the CPU) storage device (e.g., flash memory, magnetic disk, optical disk, and the like). The RAM can include an operating system 221, data storage 224, which may include one or more databases, and programs and/or applications 222, which can include, for example, software aspects of the program 223. The ROM 232 can also include Basic Input/Output System (BIOS) 220 of the electronic device.

Software aspects of the program 223 are intended to broadly include or represent all programming, applications, algorithms, models, software and other tools necessary to implement or facilitate methods and systems according to embodiments of the invention. The elements may exist on a single computer or be distributed among multiple computers, servers, devices or entities.

The power supply 206 contains one or more power components, and facilitates supply and management of power to the electronic device 200.

The input/output components, including Input/Output (I/O) interfaces 240, can include, for example, any interfaces for facilitating communication between any components of the electronic device 200, components of external devices (e.g., components of other devices of the network or system 100), and end users. For example, such components can include a network card that may be an integration of a receiver, a transmitter, a transceiver, and one or more input/output interfaces. A network card, for example, can facilitate wired or wireless communication with other devices of a network. In cases of wireless communication, an antenna can facilitate such communication. Also, some of the input/output interfaces 240 and the bus 204 can facilitate communication between components of the electronic device 200, and in an example can ease processing performed by the processor 202.

Where the electronic device 200 is a server, it can include a computing device that can be capable of sending or receiving signals, e.g., via a wired or wireless network, or may be capable of processing or storing signals, e.g., in memory as physical memory states. The server may be an application server that includes a configuration to provide one or more applications, e.g., aspects of the Engine, via a network to another device. Also, an application server may, for example, host a web site that can provide a user interface for administration of example aspects of the Engine.

Any computing device capable of sending, receiving, and processing data over a wired and/or a wireless network may act as a server, such as in facilitating aspects of implementations of the Engine. Thus, devices acting as a server may include devices such as dedicated rack-mounted servers, desktop computers, laptop computers, set top boxes, integrated devices combining one or more of the preceding devices, and the like.

Servers may vary widely in configuration and capabilities, but they generally include one or more central processing units, memory, mass data storage, a power supply, wired or wireless network interfaces, input/output interfaces, and an operating system such as Windows Server, Mac OS X, Unix, Linux, FreeBSD, and the like.

A server may include, for example, a device that is configured, or includes a configuration, to provide data or content via one or more networks to another device, such as in facilitating aspects of an example apparatus, system and method of the Engine. One or more servers may, for example, be used in hosting a Web site, such as the web site www.microsoft.com. One or more servers may host a variety of sites, such as, for example, business sites, informational sites, social networking sites, educational sites, wikis, financial sites, government sites, personal sites, and the like.

Servers may also, for example, provide a variety of services, such as Web services, third-party services, audio services, video services, email services, HTTP or HTTPS services, Instant Messaging (IM) services, Short Message Service (SMS) services, Multimedia Messaging Service (MMS) services, File Transfer Protocol (FTP) services, Voice Over IP (VOIP) services, calendaring services, phone services, and the like, all of which may work in conjunction with example aspects of an example systems and methods for the apparatus, system and method embodying the Engine. Content may include, for example, text, images, audio, video, and the like.

In example aspects of the apparatus, system and method embodying the Engine, client devices may include, for example, any computing device capable of sending and receiving data over a wired and/or a wireless network. Such client devices may include desktop computers as well as portable devices such as cellular telephones, smart phones, display pagers, Radio Frequency (RF) devices, Infrared (IR) devices, Personal Digital Assistants (PDAs), handheld computers, GPS-enabled devices tablet computers, sensor-equipped devices, laptop computers, set top boxes, wearable computers such as the Apple Watch and Fitbit, integrated devices combining one or more of the preceding devices, and the like.

Client devices such as client devices 102-106, as may be used in an example apparatus, system and method embodying the Engine, may range widely in terms of capabilities and features. For example, a cell phone, smart phone or tablet may have a numeric keypad and a few lines of monochrome Liquid-Crystal Display (LCD) display on which only text may be displayed. In another example, a Web-enabled client device may have a physical or virtual keyboard, data storage (such as flash memory or SD cards), accelerometers, gyroscopes, respiration sensors, body movement sensors, proximity sensors, motion sensors, ambient light sensors, moisture sensors, temperature sensors, compass, barometer, fingerprint sensor, face identification sensor using the camera, pulse sensors, heart rate variability (HRV) sensors, beats per minute (BPM) heart rate sensors, microphones (sound sensors), speakers, GPS or other location-aware capability, and a 2D or 3D touch-sensitive color screen on which both text and graphics may be displayed. In some embodiments multiple client devices may be used to collect a combination of data. For example, a smart phone may be used to collect movement data via an accelerometer and/or gyroscope and a smart watch (such as the Apple Watch) may be used to collect heart rate data. The multiple client devices (such as a smart phone and a smart watch) may be communicatively coupled.

Client devices, such as client devices 102-106, for example, as may be used in an example apparatus, system and method implementing the Engine, may run a variety of operating systems, including personal computer operating systems such as Windows, iOS or Linux, and mobile operating systems such as iOS, Android, Windows Mobile, and the like. Client devices may be used to run one or more applications that are configured to send or receive data from another computing device. Client applications may provide and receive textual content, multimedia information, and the like. Client applications may perform actions such as browsing webpages, using a web search engine, interacting with various apps stored on a smart phone, sending and receiving messages via email, SMS, or MIMS, playing games (such as fantasy sports leagues), receiving advertising, watching locally stored or streamed video, or participating in social networks.

In example aspects of the apparatus, system and method implementing the Engine, one or more networks, such as networks 110 or 112, for example, may couple servers and client devices with other computing devices, including through wireless network to client devices. A network may be enabled to employ any form of computer readable media for communicating information from one electronic device to another. The computer readable media may be non-transitory. A network may include the Internet in addition to Local Area Networks (LANs), Wide Area Networks (WANs), direct connections, such as through a Universal Serial Bus (USB) port, other forms of computer-readable media (computer-readable memories), or any combination thereof. On an interconnected set of LANs, including those based on differing architectures and protocols, a router acts as a link between LANs, enabling data to be sent from one to another.

Communication links within LANs may include twisted wire pair or coaxial cable, while communication links between networks may utilize analog telephone lines, cable lines, optical lines, full or fractional dedicated digital lines including T1, T2, T3, and T4, Integrated Services Digital Networks (ISDNs), Digital Subscriber Lines (DSLs), wireless links including satellite links, optic fiber links, or other communications links known to those skilled in the art. Furthermore, remote computers and other related electronic devices could be remotely connected to either LANs or WANs via a modem and a telephone link.

A wireless network, such as wireless network 110, as in an example apparatus, system and method implementing the Engine, may couple devices with a network. A wireless network may employ stand-alone ad-hoc networks, mesh networks, Wireless LAN (WLAN) networks, cellular networks, and the like.

A wireless network may further include an autonomous system of terminals, gateways, routers, or the like connected by wireless radio links, or the like. These connectors may be configured to move freely and randomly and organize themselves arbitrarily, such that the topology of wireless network may change rapidly. A wireless network may further employ a plurality of access technologies including 2nd (2G), 3rd (3G), 4th (4G) generation, Long Term Evolution (LTE) radio access for cellular systems, WLAN, Wireless Router (WR) mesh, and the like. Access technologies such as 2G, 2.5G, 3G, 4G, and future access networks may enable wide area coverage for client devices, such as client devices with various degrees of mobility. For example, a wireless network may enable a radio connection through a radio network access technology such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, and the like. A wireless network may include virtually any wireless communication mechanism by which information may travel between client devices and another computing device, network, and the like.

Internet Protocol (IP) may be used for transmitting data communication packets over a network of participating digital communication networks, and may include protocols such as TCP/IP, UDP, DECnet, NetBEUI, IPX, Appletalk, and the like. Versions of the Internet Protocol include IPv4 and IPv6. The Internet includes local area networks (LANs), Wide Area Networks (WANs), wireless networks, and long-haul public networks that may allow packets to be communicated between the local area networks. The packets may be transmitted between nodes in the network to sites each of which has a unique local network address. A data communication packet may be sent through the Internet from a user site via an access node connected to the Internet. The packet may be forwarded through the network nodes to any target site connected to the network provided that the site address of the target site is included in a header of the packet. Each packet communicated over the Internet may be routed via a path determined by gateways and servers that switch the packet according to the target address and the availability of a network path to connect to the target site.

The header of the packet may include, for example, the source port (16 bits), destination port (16 bits), sequence number (32 bits), acknowledgement number (32 bits), data offset (4 bits), reserved (6 bits), checksum (16 bits), urgent pointer (16 bits), options (variable number of bits in multiple of 8 bits in length), padding (may be composed of all zeros and includes a number of bits such that the header ends on a 32 bit boundary). The number of bits for each of the above may also be higher or lower.

A “content delivery network” or “content distribution network” (CDN), as may be used in an example apparatus, system and method implementing the Engine, generally refers to a distributed computer system that comprises a collection of autonomous computers linked by a network or networks, together with the software, systems, protocols and techniques designed to facilitate various services, such as the storage, caching, or transmission of content, streaming media and applications on behalf of content providers. Such services may make use of ancillary technologies including, but not limited to, “cloud computing,” distributed storage, DNS request handling, provisioning, data monitoring and reporting, content targeting, personalization, and business intelligence. A CDN may also enable an entity to operate and/or manage a third party's web site infrastructure, in whole or in part, on the third party's behalf.

A Peer-to-Peer (or P2P) computer network relies primarily on the computing power and bandwidth of the participants in the network rather than concentrating it in a given set of dedicated servers. P2P networks are typically used for connecting nodes via largely ad hoc connections. A pure peer-to-peer network does not have a notion of clients or servers, but only equal peer nodes that simultaneously function as both “clients” and “servers” to the other nodes on the network.

Embodiments of the present invention include apparatuses, systems, and methods implementing the Engine. Embodiments of the present invention may be implemented on one or more of client devices 102-106, which are communicatively coupled to servers including servers 107-109. Moreover, client devices 102-106 may be communicatively (wirelessly or wired) coupled to one another. In particular, software aspects of the Engine may be implemented in the program 223. The program 223 may be implemented on one or more client devices 102-106, one or more servers 107-109, and 113, or a combination of one or more client devices 102-106, and one or more servers 107-109 and 113.

The present disclosure relates to apparatuses, systems, and methods for enabling users to recall and access information related to previously conveyed information.

Information may be communicated to a consumer through a variety of means. For example, information may be communicated via a radio transmission. Information may also be conveyed to a user via an internet connection, or via a television (“TV”) broadcast.

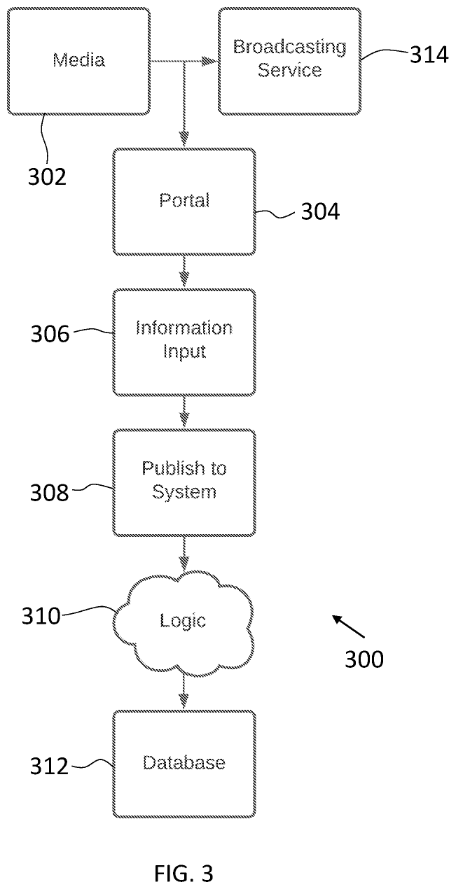

FIG. 3 shows a system for storing and indexing media data 300. Step 302 may include media for broadcasting via TV and/or radio. Such media may include an audio or audio-visual advertisement. Other media may include any information known to those skilled in the art and which is to be conveyed to a user.

In an embodiment, the media is sent to a broadcasting service 314 to be conveyed to a user. Before the media is sent to the broadcasting service 314, the media is uploaded to a portal. The portal may be an external portal that allows advertisers access. In such an embodiment, the portal may be password protected, such that only advertisers and/or administrators may access the portal. The system may assign each advertiser a unique identification number and/or password. The portal may be an online service designed to receive information about the media. Such information may contain information necessary to create an audio fingerprint, such as waveform data. Other information may include metadata about the media such as author identity, file size, file type, file name, or file modification date/time. Further, the portal may enable the publisher to view analytics regarding listener's interactions with their advertisements. For example, the portal may display analytics per listener interaction and/or the sum of all interactions across multiple listeners.

At step 306, a user may enter additional information related to the information uploaded to the portal during step 304. Such information may include a Uniform Resource Locator (“URL”), pricing information, navigation information, or a phone number. Such information may also include computer-readable instructions such as instructions to create and save a text file, or to load and play a video or song for viewing/listening on a user computer device.

At step 308, all information uploaded in steps 304 and 306 may be published to a system for further processing. In an embodiment, the system may include a dashboard showing all the recordings (for example, displayed on a monitor), the state of the recordings (for example, processed, pre-processed, analyzed, not), number of times there have been matches in a single recording, and/or number of times there have been matches across all recordings. The portal may include the ability to upload a file, and associate the URL, phone number, SVG, QR code, etc. that should be relayed to the user in the event of a match.

Turning to step 310, an audio fingerprint may be created for any audio data published in step 308. The audio fingerprint may allow media to be easily identified and matched to related data at a later time. The audio fingerprint may be a locality sensitive hash that is computed from a spectrogram of the media.

The audio fingerprint may be developed using the spectrogram. The spectrogram may be created using a fourier transform algorithm. In an embodiment, a selection of frequencies above a threshold amplitude are reduced to a scatter plot. These threshold amplitude frequencies may be identified using a high pass filter. The frequencies analyzed in the spectrogram may include several frequency intervals. As a non-limiting example, the spectrogram is used to analyze frequency intervals of 30 Hz-40 Hz, 40 Hz-80 Hz, 80 Hz-120 Hz, 120 Hz-180 Hz, and/or 180 Hz-300 Hz. However, any suitable selection of frequency intervals may be chosen. In such an example, each interval may be analyzed to identify the frequency with the highest amplitude, which is then recorded as a point on the scatter plot. The scatter plot data may be stored on the database 312 as the audio fingerprint. The points on the scatter plot may be stored on the database 312 as hash values. In an embodiment, voice recognition software and/or voice recognition utilizing AI may be used to match audio to a specific advertisement. For example, speech recognition software may break down the audio into comprehensible portions, analyze each portion of sound, use algorithms to determine the most likely word fit, and converting the sounds into text. In an embodiment, the speech recognition software may utilize natural language processing (NLP) and/or deep learning neural networks. After determining the content of the audio (for example, the text), the system may then correlate the text to the corresponding audio data and advertisement. Thus, the system may then present the URL, phone number, etc. to the listener based on the correlation made between the converted text and the advertisement data. In such an embodiment, the system may convert the advertiser's audio to speech upon uploading to the portal. Accordingly, the system may store the converted text of the advertiser's audio for more streamlined processing and correlation.

At step 312, the audio fingerprint and related data may be stored in a database. In an embodiment, the database is built and accessed through a cloud platform. In an embodiment, the database is stored locally on a user device.

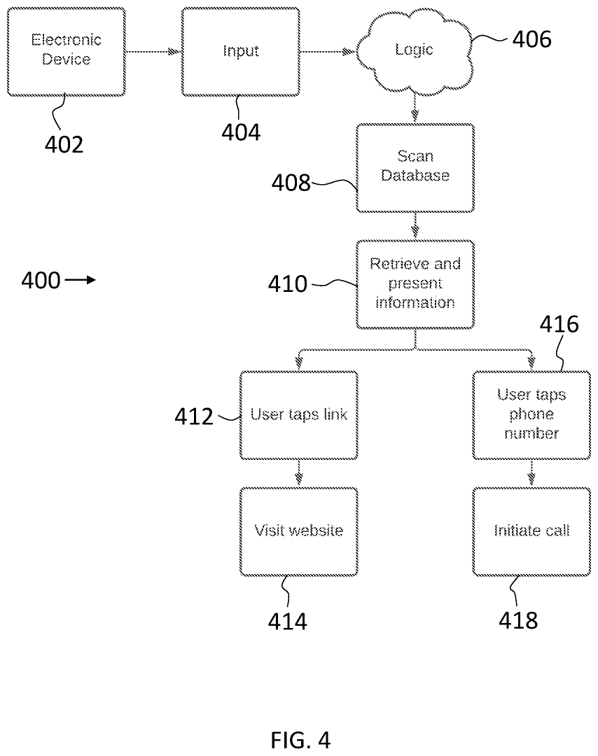

Referring to FIG. 4, the system 400 relates to how a user may make use of the system 300.

The system 400 may include an electronic device 402. Other devices may include a mobile phone, laptop, desktop computer, tablet, or any suitable electronic device. In an embodiment, the electronic device 402 includes a microphone. The microphone may be located internally within the electronic device 402, but may be located externally to the electronic device 402. The electronic device 402 may be configured to receive external audio via the microphone. In a further embodiment, the electronic device 402 includes a camera capable of capturing still images and/or video.

In an embodiment, the electronic device 402 is configured to record a series of five second audio samples. However, the electronic device 402 may be configured to record samples of any suitable length. As a non-limiting example, the electronic device 402 records audio samples continuously. In another embodiment, the electronic device 402 does not record any audio samples until an external input is received. For example, the electronic device 402 may begin recording an audio sample when a user presses a button. In another embodiment, the electronic device 402 may begin audio recording after receiving a voice command from the user (for example, while driving and utilizing a cell phone in “hands free” mode) The button may be a virtual button displayed on a screen of the user's electronic device 402. However, the button may be an external button. The external button may be a digital button, or a physical button. Such a button may be connected to the electronic device via a wired connection. Alternatively, the external button may be connected to the electronic device 402 via a wireless connection such as Bluetooth, WiFi, or infrared. The physical button may be a latching switch, or a momentary switch. In the latching switch configuration, the system 400 may record an audio sample continuously for as long as the latching switch is in an “on” position. When the electronic device 402 records an audio sample, audio data such as the waveform of the audio may be temporarily stored on an internal storage of the electronic device 402. In an alternate embodiment, the advertisement may be embedded with an identifying tone. For example, the advertisement may include a tone of a predetermined frequency, beat, tempo, cadence, or duration. In such an embodiment, the system may be configured to instruct the electronic device 402 to begin recording when the identifying tone is played. Accordingly, in such an embodiment, the electronic device 402 may be “passively listening” and begin “actively recording” once the identifying tone is heard. In a further embodiment, the identifying tone may inform the electronic device 402 of the source of the advertisement (for example, reducing the need for further processing or audio analysis). In one embodiment, the identifying tone may be configured such that it is not audible to the human ear (for example, a tone with a frequency greater than the limits of the human ear).

The electronic device 402 may include an application for processing and matching the audio sample to an audio fingerprint stored on the database 312. Once an audio sample has been recorded, it may be received by an input 404 of the application. The input 404 may compress the audio for further processing. In an embodiment, the input 404 is configured to reduce noise in the audio. In an embodiment, the audio sample may be analyzed using a logic algorithm 406. The logic algorithm may process the audio sample as described above in step 310.

At step 408, the resulting audio fingerprint may then be used to scan the database 312. The database 312 may be stored locally on the electronic device 402, or externally on a server, which may be accessed via a network. The scan may produce a match. A match may be identified when a threshold number of points from the scatter plot of the media and audio sample match. To find a match, an anchor point may be identified on the scatter plot of the media. The anchor point may include a point of the scatter plot of the audio sample. Once an anchor point has been identified, a match may be identified when the scatter points following the anchor point of the media align with the scatter points following the scatter point used to identify the anchor point.

Once a match has been identified, information relating to the media may be retrieved at step 410. Such information may include a website URL, navigation information, or phone number. The information may then be stored on the electronic device 402 to be displayed on a display of the electronic device 402. Information may be displayed on the electronic device 402 together with other relevant information such as name of the author, pricing information, or a text field. In an embodiment, a plurality of information resulting from multiple matches may be received and stored by the electronic device 402. The system may display a notification on the electronic device 402 once the advertisement has been identified, allowing the user to retrieve the information once they are able to (for example, after driving). A list of all the notifications may be sorted by date and time.

In an embodiment, if a match was not determined, the electronic device 402 may inform the user that a match could not be found. Further, the electronic device 402 may determine themes from the advertisement, without determining the source of the advertisement. In such a case, the electronic device 402 may have processed keywords or other identifiable characteristics that enable the electronic device 402 to determine the field of the underlying advertisement. Thus, the mobile device 402 may present the user with information similar to that of the unidentifiable underlying advertisement. For example, if the device 402 was unable to determine the source of a skiing instruction advertisement, but was able to process keywords related to skiing, the device 402 may present advertisements and/or information to the user relating to snow pants, ski resorts, and/or snowboards.

In an embodiment, after the audio sample has been processed, a user may interact with a URL 412 displayed on the electronic device 402 to view the related webpage 414. Alternatively, the user may interact with a phone number 416 to execute a call to that number from the user's electronic device 402. In an embodiment, the system may include a plurality of tiers, enabling the publisher to select one or more of the tiers. The tiers may correlate to the information at step 410. For example, a first tier may be configured to display a URL to the listener, while a second tier may be configured to display a URL and a phone number to the listened. Moreover, for example, a third tier may be configured to display a URL, phone number, and short message to the listener. Thus, via tier selection, the publisher may customize the information as it is presented to the listener. There may be any number or combination of tiers and the tiers may include any number and combination of information. In an embodiment, the tiers may correlate to different costs. For example, the first tier may be more affordable than the second and third tiers. Accordingly, the portal may be configured to accept payment information from the publisher.

In an embodiment, the system 400 may include speech-to-text conversion. In such an embodiment, the system 400 may store, on one or more storage devices, the transcripts correlating to each advertisement. Such transcripts may provide insight to the listening habits of the user. Based on the transcripts, the system may display certain types of information displayed in step 410. For example, the system 400 may display pricing information if the transcript contains words relating to price. As another example, the system 400 may display navigation information on the electronic device 402 if the transcript contains words relating to directions. The system 400 may not display any information on the electronic device 402 if the transcript indicates disinterest in an advertisement.

In a further embodiment, the system 300 may maintain a record of advertisements that were not uploaded by their producer. In such an embodiment, the system may determine the source of such advertisements (for example, via state corporation databases or the telephone numbers and URLs provided in the audio clip) and contact the unrepresented advertisers. Therefore, such unrepresented advertisers may be contacted and informed of the potential loss of sale due to their lack of involvement in the system. Additionally, unrepresented advertisers may be contacted and informed, in the event that media is uploaded to the system 300 from a source that is not owned by the producer of the media, to provide notice of potentially fraudulent uploads.

The system 300 may also maintain a record on the number of times advertisement information has been retrieved by the system 400. Such record may be used to analyze the success of advertisements uploaded to the system 300. Additionally, the system 300 may also maintain a record on the number of times the information presented in step 410 has been interacted with by a user. This allows for advertisers to optimize the information they include in their upload to the portal 304, and which information gets presented to the user at step 410.

In an embodiment, the system records analytics regarding the interactions between the user and the advertisement. The system may maintain records of the date and time of click, the number of clicks in total and per advertisement, the number of clicks according to device type (for example, different smart phone manufacturers or smart phone versus tablet), clicks by region (for example, determining the region by GPS information gathered via the electronic device 402 or by information entered by the user upon setup of the system), calls by region (for example, tracked by incoming area code), and number of calls per advertisement.

Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

1. A system for enhancing advertisement interaction, on an electronic device comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
receiving, from a publisher, a media content, and a media information;
creating, from the media content, at least one media audio fingerprint;
storing, on a database, the at least one media audio fingerprint and the media information;
receiving, from an electronic device, a device input
wherein the electronic device includes a microphone, and
wherein the device input is only generated upon the electronic device receiving, via the microphone, an identifying tone;
creating, from the device input, at least one input audio fingerprint;
matching at least one media audio fingerprint with at least one input audio fingerprint;
retrieving from the database the media information related to the matched media audio fingerprint;
displaying, via a display of the electronic device, the retrieved media information.

2. The system of claim 1, wherein the media information is at least one of navigation information, uniform resource locator, pricing information, or phone number.

3. The system of claim 1, wherein the electronic device is a mobile phone.

4. The system of claim 1, wherein the electronic device is a desktop computer.

5. The system of claim 1, wherein the electronic device further includes a camera.

6. The system of claim 1, wherein the device input includes a five-second audio sample.

7. The system of claim 6, wherein more than one five-second audio samples are recorded in continuous succession.

8. The system of claim 1, wherein receiving, from an electronic device, a device input, is contingent on an activation of a button.

9. The system of claim 8, wherein the button includes a digital button displayed on the display of the electronic device.

10. The system of claim 8, wherein the button includes a physical button operatively connected to the electronic device.

11. The system of claim 10, wherein the physical button is a latching switch.

12. The system of claim 1, the stored program instructions further comprising:
presenting, via the display of the electronic device, a selectable retrieved media information,
wherein interaction with the selectable retrieved media information generates one or more clicks;
recording, via the one or more storage devices, an interaction data to the database,
wherein the interaction data includes a time of the one or more clicks, a quantity of the one or more clicks per the retrieved media information, a device type, a geographical location, and a quantity of phone calls;
maintaining a portal, via the one or more storage devices, accessible by the publisher; and
displaying, via the portal, the interaction data.

13. The system of claim 12, wherein the geographical location is determined based on an area code from an outgoing phone call, via the electronic device.

14. The system of claim 13, the stored program instructions further comprising:
embedding, via the one or more processors, an identifying tone in the at least one media audio fingerprint,
wherein the electronic device is configured to begin receiving the device input based on the identifying tone.

15. The system of claim 13, the stored program instructions further comprising:
providing, via the portal, a plurality of tiers,
wherein the publisher may select from the plurality of tiers, and
wherein each of the plurality of tiers correlates to the retrieved media information; and
accepting, via the portal, a payment information from the publisher.

16. The system of claim 15, wherein the plurality of tiers includes a first tier, a second tier, and a third tier, wherein for the first tier the retrieved media information includes at least a URL, wherein for the second tier the retrieved media information includes at least the URL and a phone number, and wherein for the third tier the retrieved media information includes at least the URL, the phone number, and a message.

17. The system of claim 1, wherein the identifying tone comprises tones having a frequency above 20 kHz.

18. The system of claim 1, wherein the identifying tone comprises tones having a frequency above 20 Hz.
